(19) United States
(12) Patent Application Publication
(10) Pub. No.: US 2014/0055830 A1
(43) Pub. Date: Feb. 27, 2014

(54) PHASE MASK AND HOLOGRAPHIC RECORDING APPARATUS EMPLOYING THE SAME

(71) Applicant: SAMSUNG ELECTRONICS CO., LTD., Suwon-si (KR)

(72) Inventors: Kyoung-seok PYUN, Seoul (KR); Alexander MOROZOV, Moscow Region (RU); Chil-sung CHOI, Suwon-si (KR)

(73) Assignee: SAMSUNG ELECTRONICS CO., LTD., Suwon-si (KR)

(21) Appl. No.: 14/010,858

(22) Filed: Aug. 27, 2013

(30) Foreign Application Priority Data
Aug. 27, 2012 (KR) 10-2012-0093885

(51) Int. Cl. G03H 1/04; G02B 5/32; G02B 5/30

(52) U.S. Cl. CPC G03H 1/041; G02B 5/3083; G03H 1/0406; G02B 5/32
USPC 359/15; 359/486.01; 359/30; 359/31

(57) ABSTRACT

A phase mask includes a phase modulation layer that modulates a phase of different portions of incident light, differently, such that a different optical phase delay, in a range between 0 and 2π is imparted to different portions of the incident light. A hologram recording apparatus includes a light source; a signal beam optical system that divides a beam emitted from the light source into a reference beam and a signal beam, modulates the signal beam according to hologram pixel information, and radiates the signal beam onto a hologram recording medium. The signal beam optical system includes the phase mask. The hologram recording apparatus also includes a reference beam optical system that radiates the reference beam onto the hologram recording medium.

### CROSS-REFERENCE TO RELATED APPLICATION

This application claims priority from Korean Patent Application No. 10-2012-0093885, filed on Aug. 27, 2012, in the Korean Intellectual Property Office, the disclosure of which is incorporated herein in its entirety by reference.

### BACKGROUND

1. Field

Apparatuses consistent with exemplary embodiments relate to a hologram recording technology with an improved uniformity of a hologram.

2. Description of the Related Art

Hologram technology is a technology by which a signal can be reproduced as a stereo-scopic image by recording interference fringes between a signal beam and a reference beam. Hologram technology may be used in various ways, for example, to record and reproduce a stereo-scopic image, prevent counterfeiting, identify a genuine product, and record and reproduce digital data. Also, micro hologram technology, by which minute interference fringes are recorded on a flat plate type photosensitive recording film in pixel units to display a three-dimensional (3D) image on a two-dimensional (2D) plane is being commercialized.

In order to record a hologram, various factors, for example, optimization of light efficiency, the generation of a hogel (hologram pixel) with a desired shape, the maximization of a fill factor of a hogel, the reduction in recording time, insensitiveness to an angular selectivity when reproducing a hologram, etc. should be considered. Also, these factors should be realized without decreasing a display quality.

### SUMMARY

One or more exemplary embodiments provide a hologram recording apparatus with an improved uniformity of a hologram.

Additional exemplary aspects and advantages will be set forth in part in the description which follows and, in part, will be apparent from the description, or may be learned by practice of the presented embodiments.

According to an aspect of an exemplary embodiment, a phase mask includes: a phase modulation layer that differently modulates a phase of incident light, wherein an optical phase delay occurs spatially randomly in a range between 0 and 2π.

The phase modulation layer may be formed of a transparent material and has a non-uniform thickness having a value between 0 and nλ, wherein n denotes a refractive index of the transparent material and λ denotes a wavelength of incident light.

The phase modulation layer may have N thicknesses different from each other by location, and the N thicknesses of the phase modulation layer are uniformly distributed, wherein N denotes a natural number.

An angular spectrum of transmitted light may have a quadrilateral shape.

The phase modulation layer may be formed of a photoresist.

The phase modulation layer may have a non-uniform thickness by using a photolithography process, and a diffusing angle may be determined according to an incident angle of a beam that is shaped for exposure.

The phase mask may further include a glass substrate that supports the phase modulation layer.

According to an aspect of another exemplary embodiment, a hologram recording apparatus includes a light source; a signal beam optical system that divides a beam emitted from the light source into a reference beam and a signal beam, modulates the divided signal beam according to hologram pixel information, and radiates the modulated signal beam onto a hologram recording medium, wherein the signal beam optical system includes the phase mask of claim 1; and a reference beam optical system that radiates the reference beam onto the hologram recording medium.

The signal beam optical system may include: a beam splitting extension portion that divides the light emitted from the light source into the reference beam and the signal beam and extends a diameter of the signal beam; the phase mask; a spatial light modulator that modulates the signal beam based on hologram pixel information; and an object lens unit that focuses the signal beam modulated by the spatial light modulator on the hologram recording medium.

The beam splitting extension portion may include: a first beam splitter that divides the light emitted from the light source into the reference beam and the signal beam; and a pair of relay lenses disposed on a light path of the signal beam.

The spatial light modulator may be a reflective spatial light modulator.

The hologram recording apparatus may further include a second beam splitter that is disposed between the beam extension portion and the object lens unit and divides light in such a way that light emitted from the beam extension portion is directed to the spatial light modulator and light modulated by the spatial light modulator is directed to the object lens unit.

The beam splitting extension portion, the second beam splitter, and the object lens unit include first, second, and third holographic optical elements, respectively.

The phase mask may be integrally formed in any one of the first, second, and third holographic optical elements.

Any one of the first, second, and third holographic optical elements may be configured in such a way that a diffraction grating pattern appropriate for a function to be performed is formed in the phase mask.

The phase mask may be disposed adjacent to any one of the first, second, and third holographic optical elements.

A light guide member, for guiding light by total reflection, may further be disposed between the light source and the hologram recording medium.

The first, second, and third holographic optical elements may be disposed on the light guide member.

The reference beam optical system may include an object lens for focusing the reference beam on the hologram recording medium, and at least one minor for adjusting a light path.

### BRIEF DESCRIPTION OF THE DRAWINGS

These and/or other exemplary aspects and advantages will become apparent and more readily appreciated from the following description of exemplary embodiments, taken in conjunction with the accompanying drawings of which:

FIG. 1 a schematic view of a hologram recording apparatus according to an exemplary embodiment;

FIG. 2 is a view showing a detailed structure of a phase mask used in the hologram recording apparatus of FIG. 1;

FIG. 3 is an image showing light intensity distribution of a cross-section of a beam passing through the phase mask of FIG. 1 according to an exemplary embodiment;

FIG. 4 is a diagram showing several positions sampled to measure uniformity, after a white patch is recorded using the hologram recording apparatus of FIG. 1, according to an exemplary embodiment; and

FIG. 5 is a schematic view of a hologram recording apparatus according to another exemplary embodiment.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

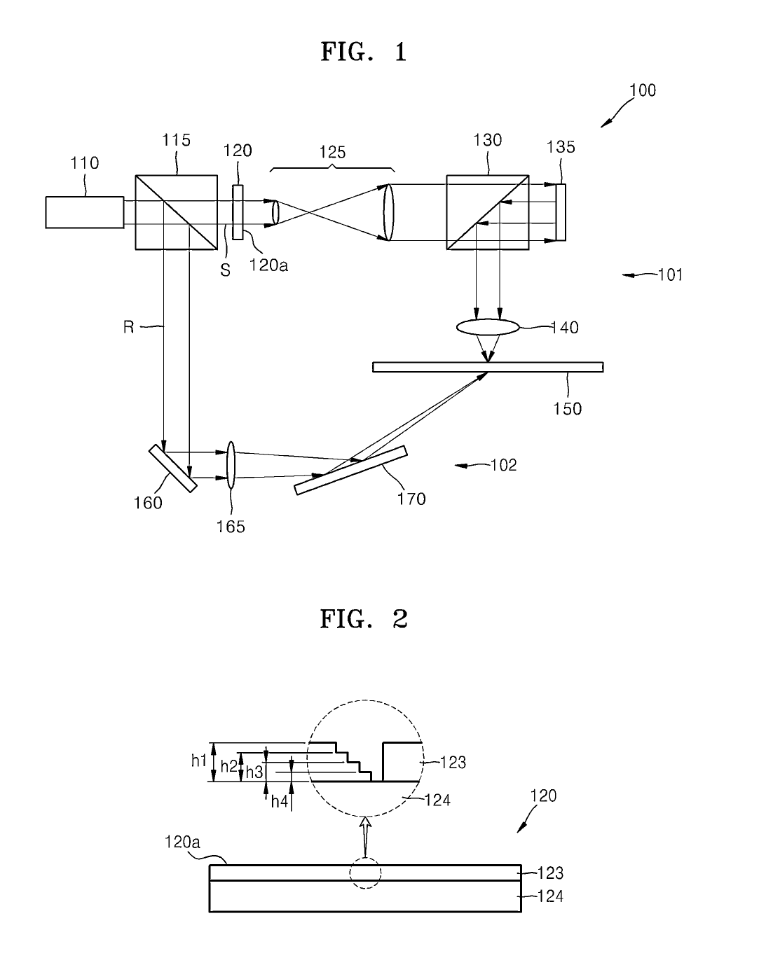

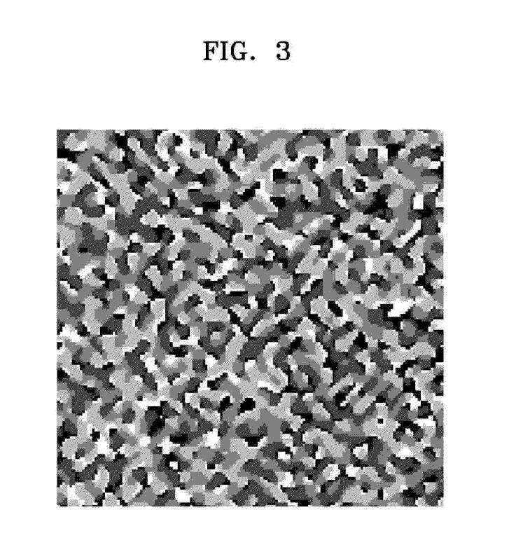

FIG. 1 a schematic view of a hologram recording apparatus 100 according to an exemplary embodiment. FIG. 2 is a view showing a detailed structure of a phase mask 120 used in the hologram recording apparatus 100 of FIG. 1. FIG. 3 is an image showing light intensity distribution of a cross-section of a beam passing through the phase mask 120 according to an exemplary embodiment.

Referring to FIG. 1, the hologram recording apparatus 100 includes a light source 110, a signal beam optical system 101 that divides a beam emitted from the light source 110 into a reference beam R and a signal beam S, modulates the divided signal beam according to hologram pixel information, and radiates the modulated signal beam onto a hologram recording medium 150, and a reference beam optical system 102 that radiates the reference beam onto the hologram recording medium 150.

The hologram recording apparatus 100 of the current embodiment uses the phase mask 120 for improving uniformity of a recorded hologram. The phase mask 120 is used to improve uniformity of a hologram and increase a fill factor of a hogel (hologram pixel). In other words, the phase mask 120 employs a structure in which an angular spectrum is formed to have a quadrilateral shape and an optical phase delay occurs spatially randomly.

Referring to FIG. 2, the phase mask 120 includes a phase modulation layer 123, and a top surface 120a of the phase modulation layer 123 is non-uniform. The phase mask 120 includes the phase modulation layer 123 to modulate a phase of incident light with a wavelength of, for example, λ, by location. In other words, depending on the location of the phase mask 120 on which the incident light is incident, the phase of the light will be modulated differently. As shown in FIG. 2, a thickness of the phase modulation layer 123 is not uniform. Also, as shown in FIG. 2, the phase mask 120 may further include a glass substrate 124 that supports the phase modulation layer 123, and a height from a top surface of the glass substrate 124 to the top surface 120a of the phase modulation layer 123 is random.

A phase modulation layer 123 is formed of a transparent material, for example, a photoresist. The phase modulation layer 123 may have a non-uniform thickness varying between 0 and nλ, where a refractive index of the transparent material forming the phase modulation layer 121 is ‘n’. For example, the phase modulation layer 123 may have N different thicknesses in different locations, and the N thicknesses of the phase modulation layer 123 may be uniformly distributed over the phase mask 120, wherein N denotes a natural number.

FIG. 2 shows the phase modulation layer 123 with five different thicknesses. In other words, the height from the top surface of the glass substrate 124 to the top surface 120a of the phase modulation layer 123 has any of five different heights: 0, h1, h2, h3, and h4. The heights h1, h2, h3, and h4 may be nλ/4, nλ/2, (3nλ)/4, and nλ, respectively. The phase modulation layer 123 has different heights to uniformly distribute light incident on the phase mask 120 into five phases of 0, π/4, π/2, (3π)/2, and 2π and delay the phase of the incident light accordingly. However, the number of a phase delay angle may vary in different ways.

The phase modulation layer 123 may have the above-described non-uniform thickness by using a photo lithography process. During this process, a diffusing angle of the phase mask 120 may be adjusted according to an incident angle of a beam that is shaped and radiated for exposure.

Referring to FIG. 3, after light that is spatially distributed at a uniform intensity passes through the phase mask 120, the light is spatially distributed randomly. In FIG. 3, a gray scale of a cross-section of a beam corresponds to the various thicknesses of the phase modulation layer 123. The inventor experimentally ascertained that uniformity of a hologram is improved when recording the hologram by using such light, which will be described below.

Hereinafter, a detailed configuration of the hologram recording apparatus 100 will be described with reference to FIG. 1.

The light source 110 may be a laser light source that outputs a coherent light, and the laser light source may be, for example, a continuous wave (CW) laser or a quasi-CW laser.

The signal beam optical system 101 is an optical system that divides a beam emitted from the light source 110 into the reference beam R and the signal beam S, modulates the divided signal beam according to hologram pixel information, and directs the modulated signal beam to the hologram recording medium 150. To this end, the signal beam optical system 101 includes a beam splitting extension portion, the phase mask 120, a spatial light modulator (SLM) 135, and an object lens unit 140.

The beam splitting extension portion may include a first beam splitter 115 dividing the beam emitted from the light source 110 into the reference beam R and the signal beam S, and a beam extension portion 125 disposed on a light path of the signal beam S.

The first beam splitter 115 may be, for example, a half mirror. The first beam splitter 115 may transmit about 50% of incident light to use the transmitted incident light as the signal beam S and may reflect about 50% of incident light to use the reflected incident light as the reference beam R. However, the ratio at which the incident light is divided into the signal beam S and the reference beam R is just an example, and the ratio may be differently set. Although FIG. 1 illustrates that light penetrating the first beam splitter 115 is the signal beam S, and light reflected by the first beam splitter 115 is the reference beam R, this is just an example. Alternatively, an optical arrangement of the hologram recording apparatus 100 may be changed so that the light penetrating the first beam splitter 115 is the reference beam R and the light reflected by the first beam splitter 115 is the signal beam S.

The beam extension portion 125 may enlarge the signal beam S, for example, into a size corresponding to an effective light modulation area of the spatial light modulator 15, and the beam extension portion 125 may be composed of a plurality of optical elements including at least one lens. The beam extension portion 125 may be composed of a pair of relay lenses as shown in FIG. 2, but this is not limiting, and the beam extension portion 125 may be composed of different elements, as would be understood by one of skill in the art.

A filter (not shown) may further be disposed between the light source 110 and the first beam splitter 115, if desired. For example, a band-pass filter for transmitting only light of a specific wavelength band may further be disposed between the light source 110 and the first beam splitter 115.

The SLM 135 modulates the signal beam S based on information regarding an image to be formed in the hologram recording medium 150, and the SLM 135 may be formed of, for example, a liquid crystal on silicon (LCoS) element.

The SLM 135 may be a reflective SLM. In this case, a second beam splitter 130 may be disposed between the beam extension portion 125 and the object lens unit 140 as shown in FIG. 1. The second beam splitter 130 divides light in such a way that light emitted from the beam extension portion 125 is directed to the SLM 135 and light modulated by the SLM 135 is directed to the object lens unit 140.

The second beam splitter 130 may be a half mirror that reflects a portion of incident light and transmits the rest of the incident light. Alternatively, the second beam splitter 130 may be a polarizing beam splitter that transmits or reflects light according to a polarization direction of the incident light. In this case, a polarizing plate (not shown) that transmits only light in a specific polarizing direction may further be disposed on a light path of light directed to the second beam splitter 130. Also, a quarter-wave plate (not shown) may further be disposed between the second beam splitter 130 and the SLM 135.

The above description is about a case where the SLM 135 is a reflective SLM. However, this is just an example, and the SLM 135 may be a transmissive SLM. In this case, the second beam splitter 130 is omitted.

In FIG. 2, the phase mask 120 is disposed between the first beam splitter 115 and the beam extension portion 125. However, this is just an example, and the phase mask 120 may be disposed in another location. For example, the phase mask 120 may be disposed between the beam extension portion 125 and the second beam splitter 130 or between the second beam splitter 130 and the object lens unit 140.

The object lens unit 140 functions as a Fourier transformation optical system that Fourier transforms the signal beam S modulated by the SLM 135, that is, the signal beam S including information regarding an image and focuses the signal beam on the hologram recording medium 150. Although the object lens unit 140 is composed of only one lens in FIG. 1, this is just an example. Thus, the object lens unit 140 may be composed of two or more lenses, or the object lens unit 140 may include another optical element.

The reference beam optical system 102 transmits the reference light R divided from the first beam splitter 115 to the hologram recording medium 150. The reference beam optical system 102 includes an object lens 165 and at least one mirror for adjusting a light path. Although two minors 160 and 170 are shown in FIG. 1, this is just an example, and thus the reference beam optical system 102 may be modified to various configurations. For example, the minors 160 and 170 may be configured to be rotatable and movable so that the reference beam R is incident on a desired position of the hologram recording medium 150 at a desired incident angle. In particular, the reference beam optical system 102 may be configured in such a way that the reference beam R and the signal beam S are incident on the same position of the hologram recording medium 150. Also, the reference beam optical system 102 may be configured in such a way that a cross-section of the reference beam R is matched with a cross-section of the signal beam S on the hologram recording medium 150.

In the above-described hologram recording apparatus 100, the signal beam S including information regarding an image encounters the reference beam R in the hologram recording medium 150, and interference fringes generated when the signal beam S and the reference beam R interfere in each other are recorded in the hologram recording medium 150.

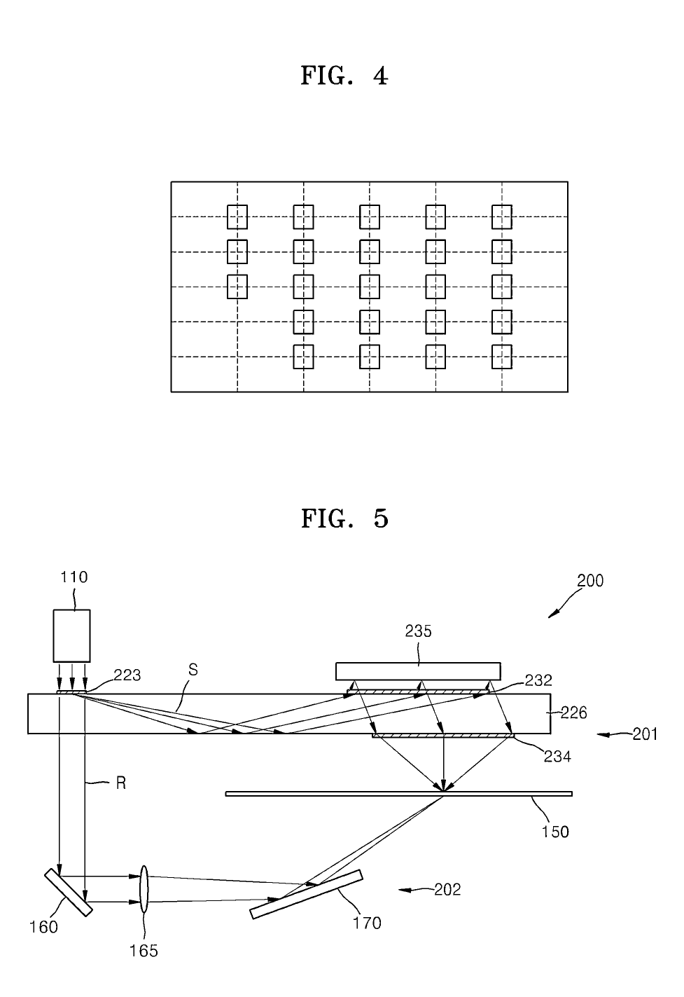

FIG. 4 is a diagram showing several positions sampled to measure uniformity, after a white patch is recorded using the hologram recording apparatus 100 of FIG. 1, according to an embodiment of the present invention.

There are twenty three sampling positions as shown in Table below. After brightness of the sampling positions is measured, uniformity is analyzed as shown below.

First, the brightness of the sampling positions is shown in Table below.

| | | | | |
|---|---|---|---|---|
| 97 | 97 | 108 | 95 | 87 |
| 102 | 106 | 109 | 104 | 90 |
| 98 | 105 | 111 | 105 | 85 |
| | 94 | 104 | 98 | 88 |
| | 102 | 105 | 96 | 80 |

Variables shown in Table below are obtained by Equation, 1−(variable/average_T1), by using a value, i.e., average_T1, obtained by averaging all values shown in Table above.

| | | | | |
|---|---|---|---|---|
| 0.015446 | 0.015446 | 0.096205 | 0.035746 | 0.116946 |
| 0.035305 | 0.075905 | 0.106355 | 0.055605 | 0.086496 |
| 0.005296 | 0.065755 | 0.126655 | 0.065755 | 0.137246 |
| | 0.045896 | 0.055605 | 0.005296 | 0.106796 |
| | 0.035305 | 0.065755 | 0.025596 | 0.187996 |

Next, percent image uniformity (PIU) is calculated as follows, from an average, i.e., average_T2, of all the variables shown in Table above.

PIU=100×(1−average_T2)

The PIU obtained through the above-described process is 93%, which is an improved value compared to the uniformity of a hologram recorded in a general hologram recording apparatus that does not use the phase mask 120 of the present exemplary embodiment. Also, a fill factor of a hologram pixel is analyzed as 90%, which is an improved value compared to the uniformity, i.e., 40%, of a hologram recorded in a general hologram recording apparatus.

FIG. 5 is a schematic view of a hologram recording apparatus 200 according to another exemplary embodiment.

The hologram recording apparatus 200 includes the light source 110, a signal beam optical system 201 that divides a beam emitted from the light source 110 into a reference beam R and a signal beam S, modulates the divided signal beam according to hologram pixel information, and radiates the modulated signal beam onto the hologram recording medium 150, and a reference beam optical system 202 that radiates the reference beam onto the hologram recording medium 150.

Comparing the hologram recording apparatus 100 of FIG. 1 and the hologram recording apparatus 200 of the current embodiment, the hologram recording apparatus 200 further includes a light guide member 226 for guiding light between the light source 110 and the hologram recording medium 150 by total reflection. Also, the hologram recording apparatus 200 of the current embodiment has a structure modified from that of FIG. 1 in such a way that the beam splitting extension portion, the second beam splitter 130, and the object lens unit 140 of FIG. 1 is modified to a first holographic optical element (HOE) 223, a second HOE 232, and a third HOE 234, respectively.

The HOE is a kind of diffractive optical element that has a structure with a minute grating pattern and is manufactured using a holographic technology. The HOE may complexly perform various optical functions according to the structure of the grating pattern.

The light guide member 226 may be formed of a transparent plastic material or a glass material and may guide incident light by total internal reflection.

The hologram recording apparatus 200 may be made more compact by disposing the HOE with appropriate functions on the light guide member 226.

The first HOE 223 performs a beam splitting function and a beam extending function and may be disposed on the light guide member 234. If light emitted from the light source 110 is incident on the first HOE 223, the light is diffracted at a predetermined angle and is divided into the signal beam S traveling inside the light guide member 226 and the reference beam R which is transmitted through the first HOE 223. Although FIG. 4 illustrates that a beam emitted from the light source 110 is vertically incident on the first HOE 223, the present invention is not limited thereto, and thus the beam may be obliquely incident on the first HOE 223 at a predetermined angle.

The second HOE 232 collimates the signal beam S, which is guided inside the light guide member 226 and has been incident on the second HOE 232, and allows the signal beam S to be incident on the SLM 235. The second HOE 232 includes a minute grating pattern appropriate for the above-described functions of the second HOE 232. The second HOE 232 may be disposed on the light guide member 234 to face the SLM 235.

A minute grating pattern is formed in the third HOE 234 to perform a function of a Fourier objective lens. The signal beam S, which has been modulated by the SLM 235 and has passed through the light guide member 226, is incident on the third HOE 234 and is transmitted therethrough to a desired position on the hologram recording medium 150. The third HOE 234 may be disposed on the light guide member 226, opposite the hologram recording medium 150.

The phase mask 120 shown in FIG. 1 may be integrally formed with any one of the first, second, and third HOEs 223, 232, and 234 in the current embodiment. For example, the any one of the first, second, and third HOEs 223, 232, and 234 may be configured in such a way that a diffraction pattern appropriate for a function to be performed is formed in the phase mask 120 having the above-described structure.

The reference beam optical system 202 transfers the reference beam R divided from the first HOE 223 to the hologram recording medium 150 and includes the object lens 165 and at least one minor for adjusting a light path. Although FIG. 5 illustrates that the reference beam optical system 202 have the same configuration as the reference beam optical system 102 shown in FIG. 1, this is just an example. Thus, the reference beam optical system 202 may be modified to have a structure using a light guide member and an HOE, similar to the signal beam optical system 201.

The above-described phase mask improves uniformity of an optical system for recording a hologram and improves a fill factor of a hogel.

Accordingly, the hologram recording apparatus using the above-described phase mask has an improved uniformity between pixels and may record a hologram that is insensitive to an angular selectivity.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A phase mask comprising:
a phase modulation layer that modulates a phase of incident light, such that the phase modulation layer imparts an optical phase delay to the incident light based on a location of the phase modulation layer on which the incident light is incident, wherein the optical phase delay is in a range between 0 and 2π.

2. The phase mask of claim 1, wherein the phase modulation layer comprises a transparent material with a non-uniform thickness having a value between 0 and nλ, wherein n is a refractive index of the transparent material and λ is denotes a wavelength of the incident light.

3. The phase mask of claim 2, wherein the non-uniform thickness of the transparent material varies among N different thicknesses, wherein N is a natural number.

4. The phase mask of claim 1, wherein a cross-section of light transmitted by the phase mask has a quadrilateral shape.

5. The phase mask of claim 2, wherein the phase modulation layer comprises a photoresist.

6. The phase mask of claim 2, wherein a thickness of the phase modulation layer is non-uniform, and the phase modulation layer is formed using a photolithography process in which a diffusing angle is determined according to an incident angle of a beam that is shaped for exposure.

7. The phase mask of claim 1, further comprising a glass substrate that supports the phase modulation layer.

8. A hologram recording apparatus comprising:
a light source;
a signal beam optical system comprising:
a beam splitter that divides a beam emitted from the light source into a reference beam and a signal beam,
a spatial light modulator that modulates the signal beam according to hologram pixel information, and radiates the modulated signal beam onto a hologram recording medium, and
a phase modulation layer that modulates a phase of the signal beam, such that the phase modulation layer imparts an optical phase delay to the signal beam based on a location of the phase modulation layer on which the signal beam is incident,
wherein the optical phase delay is in a range between 0 and 2π; and
a reference beam optical system that radiates the reference beam onto the hologram recording medium.

9. The hologram recording apparatus of claim 8, wherein the signal beam optical system further comprises:
a beam extension portion that extends a diameter of the signal beam; and
an object lens unit that focuses the modulated signal beam modulated by the spatial light modulator on the hologram recording medium.

10. The hologram recording apparatus of claim 9, wherein the beam extension portion comprises:
a pair of relay lenses disposed on a light path of the signal beam.

11. The hologram recording apparatus of claim 9, wherein the spatial light modulator is a reflective spatial light modulator.

12. The hologram recording apparatus of claim 11, wherein the beam splitter is a first beam splitter and the hologram apparatus further comprises a second beam splitter disposed between the beam extension portion and the object lens unit, wherein the second beam splitter divides light incident thereon such that light emitted from the beam extension portion is directed to the spatial light modulator and light modulated by the spatial light modulator is directed to the object lens unit.

13. The hologram recording apparatus of claim 12, wherein the beam splitting extension portion, the second beam splitter, and the object lens unit comprise a first holographic optical element, a second holographic optical element, and a third holographic optical element, respectively.

14. The hologram recording apparatus of claim 13, wherein the phase mask is integrally formed with one of the first holographic optical element, the second holographic optical element, and the third holographic optical element.

15. The hologram recording apparatus of claim 14, wherein one of the first holographic optical element, the second holographic optical element, and the third holographic optical element comprises a diffraction grating pattern formed in the phase mask.

16. The hologram recording apparatus of claim 13, wherein the phase mask is disposed adjacent to one of the first holographic optical element, the second holographic optical element, and the third holographic optical element.

17. The hologram recording apparatus of claim 13, further comprising a light guide member, which guides light by total internal reflection, disposed between the light source and the hologram recording medium.

18. The hologram recording apparatus of claim 17, wherein the first holographic optical element, the second holographic optical element, and the third holographic optical element are disposed on the light guide member.

19. The hologram recording apparatus of claim 8, wherein the reference beam optical system comprises an object lens for focusing the reference beam on the hologram recording medium, and at least one minor for adjusting a light path.

20. A hologram recording apparatus comprising:
a light source;
a beam splitter which divides light from the light source into a reference beam and a signal beam;
a phase modulation layer which modulates a phase of the signal beam such that a different optical phase delay is imparted to each of a plurality of portions of the signal beam, wherein the optical phase delay is in a range between 0 and 2π;
a spatial light modulator which modulates the signal beam according to hologram pixel information.
